(19) United States
(12) Patent Application Publication
(10) Pub. No.: US 2021/0403027 A1
(43) Pub. Date: Dec. 30, 2021

(54) INFORMATION PROCESSING DEVICE, INFORMATION PROCESSING SYSTEM, PROGRAM, AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/341,502

(22) Filed: Jun. 8, 2021

(30) Foreign Application Priority Data
Jun. 29, 2020 (JP) 2020-112024

(51) Int. Cl. B60W 60/00; G07C 5/00; G06K 9/00

(52) U.S. Cl. CPC B60W 60/001; B60W 2554/4049; G06K 9/00812; G07C 5/008

(57) ABSTRACT

An information processing device includes a control unit. The control unit acquires operation information related to driving of a vehicle and position information of the vehicle, generates improvement information on a traveling environment of the vehicle when the control unit determines that the operation information that is acquired has reached a threshold value, the improvement information including the position information when the operation information reaches the threshold value, and provides the improvement information that is generated to a service facility.

### CROSS-REFERENCE TO RELATED APPLICATION

This application claims priority to Japanese Patent Application No. 2020-112024 filed on Jun. 29, 2020, incorporated herein by reference in its entirety.

### BACKGROUND

### 1. Technical Field

The present disclosure relates to an information processing device, an information processing system, a program, and a vehicle.

### 2. Description of Related Art

There is known a technique for evaluating traffic flow inside and around a parking lot. For example, Japanese Patent No. 3001777 (JP 3001777 B) discloses a parking lot traffic flow simulation method used for evaluating traffic flow inside and around a parking lot. In such a parking lot traffic flow simulation method, the layout of the parking lot is represented by a group of meshes of a certain size having attributes, and determination calculation is performed for each vehicle at regular intervals in accordance with the attributes of the meshes surrounding the vehicle. The movement of each vehicle is expressed on the layout for each calculation.

### SUMMARY

With such a technique in the related art, it is possible to evaluate the traffic flow inside and around the parking lot and support the design of the parking lot. However, a technique that improves a traveling environment of the vehicle based on operation information related to driving of the vehicle, to improve, for example, the rate of attracting customers to the service facility and the management efficiency has not been sufficiently considered.

An object of the present disclosure made in view of such circumstances is to make it possible to contribute to improving the management efficiency of the service facility by improving the traveling environment of the vehicle.

An information processing device according to an embodiment of the present disclosure includes a control unit that acquires operation information related to driving of a vehicle and position information of the vehicle, generates improvement information on a traveling environment of the vehicle when the control unit determines that the operation information that is acquired has reached a threshold value, the improvement information including the position information when the operation information reaches the threshold value, and provides the improvement information that is generated to a service facility.

A program according to an embodiment of the present disclosure causes an information processing device to perform operations including: acquiring operation information related to driving of a vehicle and position information of the vehicle; determining whether the operation information that is acquired has reached a threshold value; generating improvement information on a traveling environment of the vehicle when the information processing device determines that the operation information that is acquired has reached the threshold value, the improvement information including the position information when the operation information reaches the threshold value; and providing the improvement information that is generated to a service facility.

A vehicle according to an embodiment of the present disclosure includes a control unit that acquires operation information related to driving of the vehicle and position information of the vehicle, generates improvement information on a traveling environment of the vehicle when the control unit determines that the operation information that is acquired has reached a threshold value, the improvement information including the position information when the operation information reaches the threshold value, and provides the improvement information that is generated to a service facility.

With the information processing device, the information processing system, the program, and the vehicle according to the embodiments of the present disclosure, it is possible to contribute to improving the management efficiency of the service facility by improving the traveling environment of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a configuration of an information processing system including an information processing device according to an embodiment of the present disclosure;

FIG. 2 is a functional block diagram showing a schematic configuration of each of the information processing device, a vehicle, and a terminal device shown in FIG. 1;

FIG. 3 is a diagram illustrating an example of a process executed by a control unit of the information processing device shown in FIG. 2; and

FIG. 4 is a flowchart illustrating an example of an information processing method executed by the information processing device shown in FIG. 1.

### DETAILED DESCRIPTION OF EMBODIMENTS

Hereinafter, an embodiment of the present disclosure will be described below with reference to the drawings.

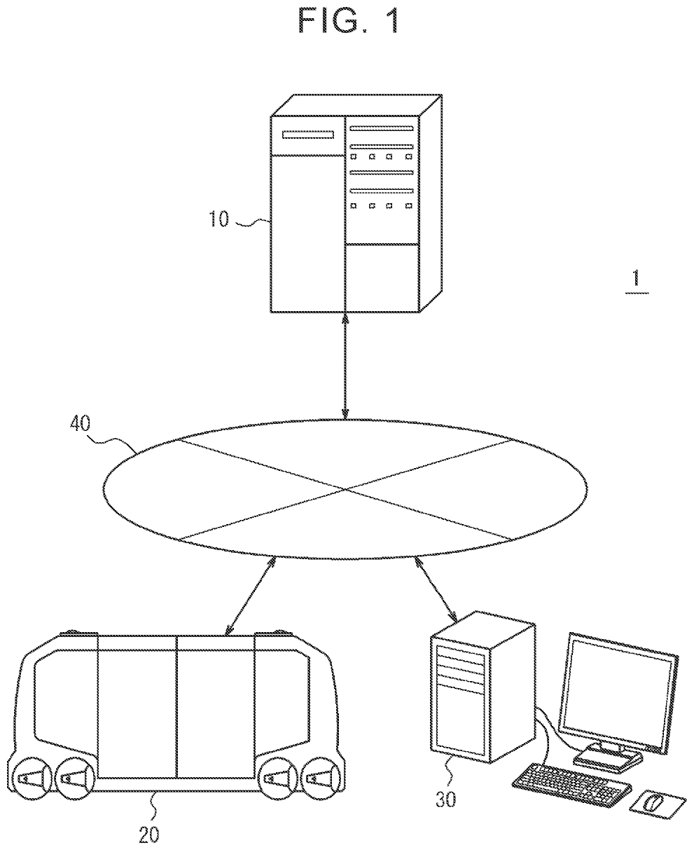

FIG. 1 is a configuration diagram showing a configuration of an information processing system 1 including an information processing device 10 according to an embodiment of the present disclosure. An outline of the information processing system 1 including the information processing device 10 according to the embodiment of the present disclosure will be mainly described with reference to FIG. 1. The information processing system 1 includes a vehicle 20 and a terminal device 30 in addition to the information processing device 10.

For convenience of description, FIG. 1 shows a single information processing device 10, a single vehicle 20, and a single terminal device 30. However, the numbers of the information processing devices 10, the vehicles 20, and the terminal devices 30 included in the information processing system 1 may be two or more. For example, an occupant may continuously use the same vehicle 20, or may use any one of a plurality of the vehicles 20 while changing the vehicle 20 for each ride or by a predetermined period. The number of occupants of the vehicle 20 may be one or more. Each of the information processing device 10, the vehicle 20, and the terminal device 30 is connected to a network 40 including a mobile communication network and the Internet, for example, so as to be able to communicate with each other.

The information processing device 10 is a server or a plurality of servers that can communicate with each other. The information processing device 10 is not limited to the above, and may be any general-purpose electronic device such as a personal computer (PC) or a smartphone, or may be another electronic device dedicated to the information processing system 1.

The vehicle 20 is, for example, an automobile. The vehicle 20 is not limited to this, and may be any vehicle that allows a human to board and drive to a destination. The vehicle 20 is, for example, a vehicle that performs autonomous driving. Autonomous driving includes, for example, Levels 1 to 5 defined by the Society of Automotive Engineers (SAE). However, autonomous driving is not limited to the above, and may be appropriately defined. The vehicle 20 is not limited to the vehicle that performs autonomous driving, and may be any vehicle driven by a driver.

The terminal device 30 is a general-purpose electronic device such as a PC or a smartphone. The terminal device 30 is, for example, an electronic device used by a staff member of a service facility used by an occupant of the vehicle 20. The terminal device 30 is not limited to this, and may be a single server device or a plurality of server devices used in a service facility and capable of communicating with each other, or may be an electronic device dedicated to the information processing system 1. In the present specification, the “service facility” includes facilities that provide services related to, for example, retail, accommodation, food and beverage, health, healing, entertainment, and the like.

As an outline of the embodiment, the information processing device 10 acquires operation information related to driving of the vehicle 20 and position information of the vehicle 20. In the present specification, the “operation information” includes, for example, any information reflecting an operation related to driving by the driver of the vehicle 20 or autonomous driving of the vehicle 20. For example, the “operation information” includes the steering angle, the degree of change in the steering angle, and the like, which reflects the steering operation. For example, the “operation information” includes the amount of depression of the brake, the degree of change in the amount of depression of the brake, and the like, which reflects the brake operation. In the present specification, the “degree of change” includes the amount of change, the rate of change, and the like in the target parameter within a predetermined time, for example, a unit time. In the present specification, the “position information” includes, for example, an address, latitude, longitude, altitude, and the like.

When the information processing device 10 determines that the acquired operation information related to driving of the vehicle 20 has reached a threshold value, the information processing device 10 generates improvement information on the traveling environment of the vehicle 20 including the position information of the vehicle 20 when the operation information reaches the threshold value. The information processing device 10 provides the generated improvement information to the service facility.

In the present specification, the “threshold value” includes, for example, a predetermined value set for a parameter indicating the operation information. For example, the “threshold value” is preset by the staff member of the service facility, a manager of the information processing system 1, or the occupant of the vehicle 20 prior to the addition of the vehicle 20 to the information processing system 1 and the start of use of the vehicle 20. The “threshold value” is not limited to this, and may be appropriately set by, for example, the staff member of the service facility, the manager of the information processing system 1, or the occupant of the vehicle 20 after the use of the vehicle 20 is started.

In the present specification, the “improvement information” includes, for example, any information necessary for improving the traveling environment of the vehicle 20 so that the service facility can improve the rate of attracting customers and, accordingly, the management efficiency. For example, the “improvement information” includes the position information of the vehicle 20 when the operation information reaches the threshold value, as described above. The “improvement information” is not limited to this, and may include, for example, at least one of the improvement method of the traveling environment and a traveling image of the vehicle 20 when the operation information reaches the threshold value, in addition to the position information of the vehicle 20.

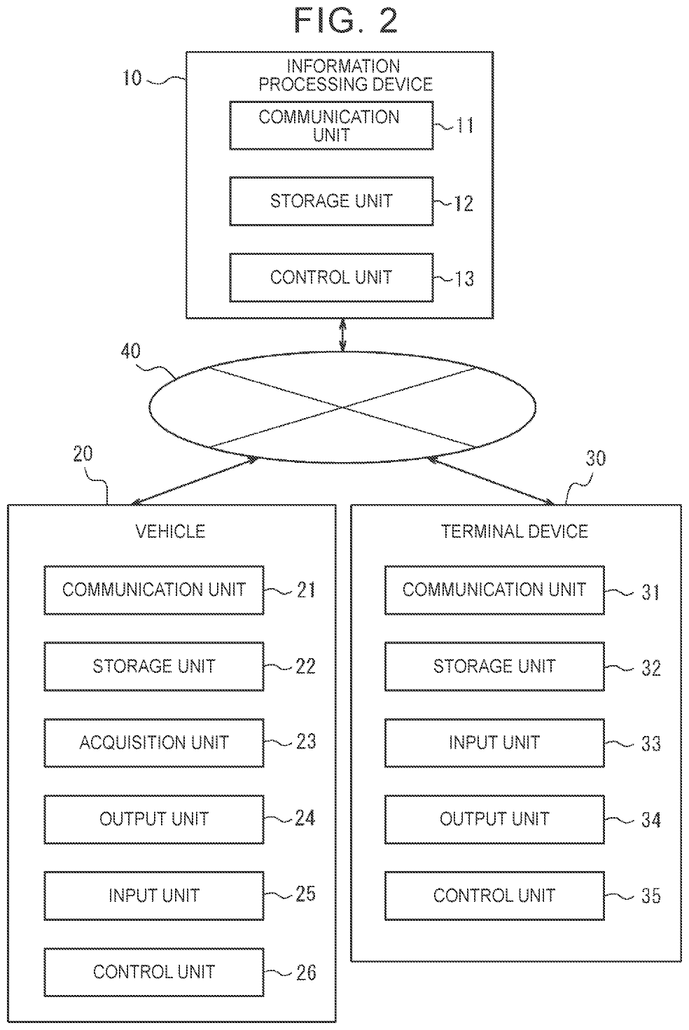

Next, with reference to FIG. 2, configurations of the information processing device 10, the vehicle 20, and the terminal device 30 included in the information processing system 1 will be mainly described. FIG. 2 is a functional block diagram showing a schematic configuration of each of the information processing device 10, the vehicle 20, and the terminal device 30 shown in FIG. 1.

As shown in FIG. 2, the vehicle 20 includes a communication unit 21, a storage unit 22, an acquisition unit 23, an output unit 24, an input unit 25, and a control unit 26. The communication unit 21, the storage unit 22, the acquisition unit 23, the output unit 24, the input unit 25, and the control unit 26 are connected to each other so as to be able to communicate with each other via an in-vehicle network such as a controller area network (CAN) or a dedicated line.

The communication unit 21 includes a communication module connected to the network 40. For example, the communication unit 21 may include a communication module compatible with mobile communication standards such as the fourth generation (4G) and the fifth generation (5G). According to the embodiment, the vehicle 20 is connected to the network 40 via the communication unit 21. The communication unit 21 transmits and receives various types of information via the network 40.

The storage unit 22 is, for example, a semiconductor memory, a magnetic memory, or an optical memory. However, the storage unit 22 is not limited to these memories. The storage unit 22 may function as, for example, a main storage device, an auxiliary storage device, or a cache memory. The storage unit 22 stores any information used for operation of the vehicle 20. For example, the storage unit 22 stores the operation information and the position information of the vehicle 20 acquired by the acquisition unit 23. In addition, for example, the storage unit 22 may store a system program, an application program, and various types of information received by the communication unit 21. The information stored in the storage unit 22 may be updatable with information received from the network 40 via the communication unit 21, for example.

The acquisition unit 23 includes any module capable of acquiring the operation information related to driving of the vehicle 20. For example, the acquisition unit 23 includes a sensor module capable of acquiring various types of operation information described above. For example, the acquisition unit 23 includes a steering angle sensor, a brake sensor, and the like. The acquisition unit 23 includes any module capable of acquiring the traveling image of the vehicle 20. For example, the acquisition unit 23 may include a camera module that is installed outside the vehicle cabin of the vehicle 20 and that is connected to the CAN so that the outside of the vehicle 20 can be imaged.

The acquisition unit 23 includes one or more receivers corresponding to any satellite positioning system. For example, the acquisition unit 23 may include a global positioning system (GPS) receiver. The acquisition unit 23 acquires the measured value of the position of the vehicle 20 as the position information of the vehicle 20. The acquisition unit 23 may acquire the position information of the vehicle 20 constantly or may acquire the position information periodically or irregularly.

The output unit 24 outputs, for example, the information received by the communication unit 21 to the occupant in the vehicle cabin of the vehicle 20. For example, the output unit 24 includes a car navigation device. For example, the output unit 24 includes an output device such as a liquid crystal monitor that constitutes the car navigation device. The car navigation device constituting the output unit 24 outputs, for example, information using at least either of an image and a sound.

The output unit 24 is not limited to this, and may include any output device that affects at least either of visual and auditory senses of the occupant of the vehicle 20. The output unit 24 may include, for example, any audio output device other than the car navigation device, which mainly affects the auditory sense of the occupant of the vehicle 20. The output unit 24 may include, for example, any image output device other than the car navigation device, which mainly affects the visual sense of the occupant of the vehicle 20.

The input unit 25 includes, for example, one or more input interfaces that receive an input operation by the occupant in response to the information output by the output unit 24 and acquire input information based on the input operation by the occupant. For example, the input unit 25 includes a car navigation device that constitutes the output unit 24. For example, the input unit 25 includes a touch screen provided integrally with the liquid crystal monitor constituting the car navigation device. The car navigation device constituting the input unit 25 receives, for example, the input operation by the occupant based on a touch operation by the occupant.

The input unit 25 is not limited to this, and may include any input interface capable of detecting the input operation by the occupant and acquiring the input information based on the input operation by the occupant. The input unit 25 may include, for example, a physical key, a capacitance key, and a microphone that accepts voice inputs.

The control unit 26 includes one or more processors. According to the embodiment, the “processor” is a general-purpose processor or a dedicated processor specialized for specific processing. However, the processor is not limited thereto. For example, the control unit 26 may include an electronic control unit (ECU). The control unit 26 is connected to each component constituting the vehicle 20 so as to be able to communicate with each other and controls the operation of the entire vehicle 20.

The control unit 26 acquires the operation information and the position information of the vehicle 20 by using the acquisition unit 23. The control unit 26 transmits the operation information and the position information of the vehicle 20 acquired by the acquisition unit 23 to the information processing device 10 via the communication unit 21 and the network 40.

The control unit 26 receives the improvement information generated by the information processing device 10 from the information processing device 10 via the network 40 and the communication unit 21 as necessary. The control unit 26 outputs the improvement information received from the information processing device 10 to the output unit 24.

For example, the control unit 26 receives route information to the service facility serving as a destination and determined by the information processing device 10 or any other external device via the network 40 and the communication unit 21. For example, the control unit 26 receives information on the autonomous driving state determined by the information processing device 10 or any other external device via the network 40 and the communication unit 21. In the present specification, the “information on the autonomous driving state” includes, for example, speed, acceleration, angular velocity, shift lever operation, steering operation, traveling lane, and the like of the vehicle 20.

The control unit 26 executes vehicle control for the vehicle 20 based on, for example, the received route information to the destination and the information on the autonomous driving state. In the present specification, the “vehicle control” includes, but is not limited to, autonomous driving to the service facility serving as a destination, for example. For example, the control unit 26 may display the received route information to the destination on the output unit 24 and only assist the driver of the vehicle 20 in driving.

Next, the configuration of the terminal device 30 included in the information processing system 1 will be mainly described. As shown in FIG. 2, the terminal device 30 includes a communication unit 31, a storage unit 32, an input unit 33, an output unit 34, and a control unit 35.

The communication unit 31 includes a communication module connected to the network 40. For example, the communication unit 31 may include a communication module compatible with mobile communication standards such as the 4G and the 5G or the Internet standards. According to the embodiment, the terminal device 30 is connected to the network 40 via the communication unit 31. The communication unit 31 transmits and receives various types of information via the network 40.

The storage unit 32 is, for example, a semiconductor memory, a magnetic memory, or an optical memory. However, the storage unit 32 is not limited to these memories. The storage unit 32 may function as, for example, a main storage device, an auxiliary storage device, or a cache memory. The storage unit 32 stores any information used for the operation of the terminal device 30. For example, the storage unit 32 stores facility information and the like of the service facility that owns the terminal device 30. In the present specification, the “facility information of the service facility” includes, for example, information related to the position information, type, and equipment of the service facility. In addition, for example, the storage unit 32 may store a system program, an application program, and various types of information received by the communication unit 31. The information stored in the storage unit 32 may be updatable with information received from the network 40 via the communication unit 31, for example.

The input unit 33 includes one or more input interfaces that detect user input and acquire input information based on the user's operation. For example, the input unit 33 may include a physical key, a capacitive key, a touch screen integrated with a display of the output unit 34, a microphone that accepts voice input, and the like.

The output unit 34 includes one or more output interfaces that output information to notify the user. For example, the output unit 34 is, but is not limited to, a display that outputs information as images, a speaker that outputs information as audio, and the like.

The control unit 35 includes one or more processors. According to the embodiment, the “processor” is a general-purpose processor or a dedicated processor specialized for specific processing. However, the processor is not limited thereto. The control unit 35 is connected to each of the components constituting the terminal device 30 so as to be able to communicate with each other and controls the operation of the entire terminal device 30.

For example, the control unit 35 receives the improvement information generated by the information processing device 10 from the information processing device 10 via the network 40 and the communication unit 31. For example, the control unit 35 transmits the facility information of the service facility stored in the storage unit 32 to the information processing device 10 via the communication unit 31 and the network 40.

Next, the configuration of the information processing device 10 included in the information processing system 1 will be mainly described. As shown in FIG. 2, the information processing device 10 includes a communication unit 11, a storage unit 12, and a control unit 13.

The communication unit 11 includes a communication module connected to the network 40. For example, the communication unit 11 may include a communication module compatible with mobile communication standards such as the 4G and the 5G or the Internet standards. According to the embodiment, the information processing device 10 is connected to the network 40 via the communication unit 11. The communication unit 11 transmits and receives various types of information via the network 40.

The storage unit 12 is, for example, a semiconductor memory, a magnetic memory, or an optical memory. However, the storage unit 12 is not limited to these memories. The storage unit 12 may function as, for example, a main storage device, an auxiliary storage device, or a cache memory. The storage unit 12 stores any information used for the operation of the information processing device 10. For example, the storage unit 12 may store a system program, an application program, and various types of information received by the communication unit 11. The information stored in the storage unit 12 may be updatable with information received from the network 40 via the communication unit 11, for example.

The control unit 13 includes one or more processors. According to the embodiment, the “processor” is a general-purpose processor or a dedicated processor specialized for specific processing. However, the processor is not limited thereto. The control unit 13 is connected to each of the components constituting the information processing device 10 so as to be able to communicate with each other and controls the operation of the entire information processing device 10.

The control unit 13 acquires the operation information related to driving of the vehicle 20 and the position information of the vehicle 20. For example, the control unit 13 receives the operation information and the position information of the vehicle 20 acquired by the acquisition unit 23 of the vehicle 20 from the vehicle 20 via the network 40 and the communication unit 11. The control unit 13 determines whether the acquired operation information has reached the threshold value.

When the control unit 13 determines that the acquired operation information has reached the threshold value, the control unit 13 generates the improvement information on the traveling environment of the vehicle 20 including the position information of the vehicle 20 when the operation information reaches the threshold value. Similarly, the control unit 13 may generate the improvement information including the improvement method of the traveling environment of the vehicle 20 based on at least one of the position information and the operation information of the vehicle 20 when the operation information reaches the threshold value. Further, the control unit 13 may acquire the traveling image of the outside of the vehicle 20 and generate the improvement information including the traveling image of the vehicle 20 when the operation information reaches the threshold value.

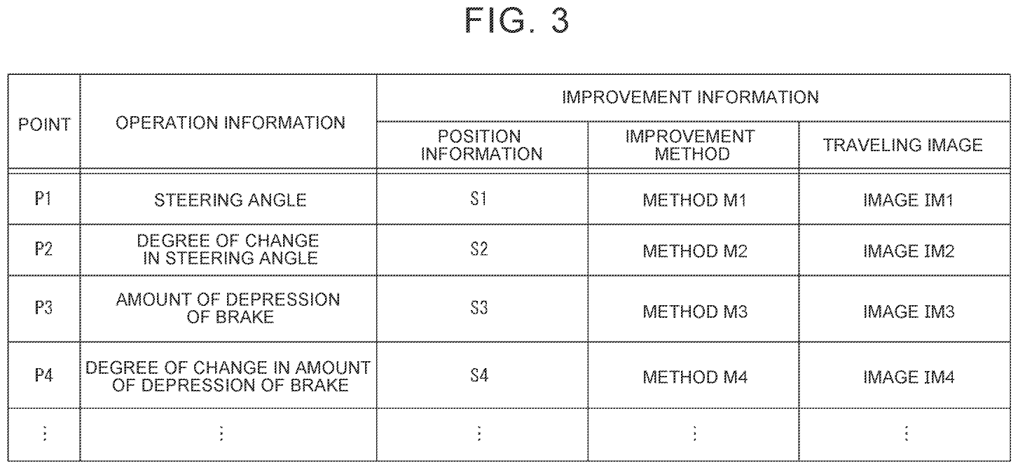

FIG. 3 is a diagram illustrating an example of a process executed by the control unit 13 of the information processing device 10 shown in FIG. 2. The example of the process executed by the control unit 13 will be described more specifically with reference to FIG. 3.

In the example of the process executed by the control unit 13, the improvement information on the traveling environment of the vehicle 20 is generated based on the operation information and the position information of the vehicle 20 acquired by the control unit 13. Although four points P1, P2, P3, and P4 are shown in FIG. 3, the number of points corresponding to the plurality of improvement information generated by the control unit 13 does not have to be four.

The control unit 13 acquires information on the steering angle related to driving of the vehicle 20 from the vehicle 20 as operation information. At this time, the control unit 13 determines whether the acquired steering angle has reached the threshold value. When the control unit 13 determines that the acquired steering angle has reached the threshold value, the control unit 13 generates position information S1 of the vehicle 20 when the steering angle reaches the threshold value as the improvement information on the traveling environment of the vehicle 20.

In addition, the control unit 13 may generate an improvement method M1 of the traveling environment of the vehicle 20 as the improvement information on the traveling environment of the vehicle 20 based on at least one of the position information S1 of the vehicle 20 and the steering angle when the steering angle reaches the threshold value.

For example, the control unit 13 may acquire information indicating that the curvature of the curve at the point P1 is large based on the position information S1 of the vehicle 20 when the steering angle reaches the threshold value, and generate the reduction of the curvature of the curve as the improvement method M1. For example, the control unit 13 may estimate that the curvature of the curve at the point P1 is large based on the steering angle when the steering angle reaches the threshold value, and generate the reduction of the curvature of the curve as the improvement method M1. For example, the control unit 13 may execute an acquisition process and an estimation process of information related to the curvature of the curve in parallel based on the position information S1 of the vehicle 20 and the steering angle when the steering angle reaches the threshold value, and generate the reduction of the curvature of the curve as the improvement method M1.

In addition, the control unit 13 may generate a traveling image IM1 of the vehicle 20 when the steering angle reaches the threshold value as the improvement information on the traveling environment of the vehicle 20. As described above, in the example of the process executed by the control unit 13, the improvement information on the traveling environment of the vehicle 20 may include the position information Si of the vehicle 20 when the steering angle reaches the threshold value, the improvement method M1 of the traveling environment of the vehicle 20, and the traveling image IM1 of the vehicle 20 when the steering angle reaches the threshold value.

The control unit 13 acquires information on the degree of change in the steering angle related to driving of the vehicle 20 from the vehicle 20 as operation information. At this time, the control unit 13 determines whether the acquired degree of change in the steering angle has reached the threshold value. When the control unit 13 determines that the acquired degree of change in the steering angle has reached the threshold value, the control unit 13 generates position information S2 of the vehicle 20 when the degree of change in the steering angle reaches the threshold value as the improvement information on the traveling environment of the vehicle 20.

In addition, the control unit 13 may generate an improvement method M2 of the traveling environment of the vehicle 20 as the improvement information on the traveling environment of the vehicle 20 based on at least one of the position information S2 of the vehicle 20 and the degree of change in the steering angle when the degree of change in the steering angle reaches the threshold value.

For example, the control unit 13 may acquire information indicating a sharp curve of 90° at the point P2 based on the position information S2 of the vehicle 20 when the degree of change in the steering angle reaches the threshold value, and generate providing a display of “sharp curve ahead” or providing a stop line immediately before the curve as the improvement method M2. For example, the control unit 13 may estimate information indicating a sharp curve of 90° at the point P2 based on the degree of change in the steering angle when the degree of change in the steering angle reaches the threshold value, and generate providing a display of “sharp curve ahead” or providing a stop line immediately before the curve as the improvement method M2. For example, the control unit 13 may execute an acquisition process and an estimation process of information on a sharp curve of 90° in parallel based on the position information S2 of the vehicle 20 and the degree of change in the steering angle when the degree of change in the steering angle reaches the threshold value, and generate providing a display of “sharp curve ahead” or providing a stop line immediately before the curve as the improvement method M2.

In addition, the control unit 13 may generate a traveling image IM2 of the vehicle 20 when the degree of change in the steering angle reaches the threshold value as the improvement information on the traveling environment of the vehicle 20. As described above, in the example of the process executed by the control unit 13, the improvement information on the traveling environment of the vehicle 20 may include the position information S2 of the vehicle 20 when the degree of change in the steering angle reaches the threshold value, the improvement method M2 of the traveling environment of the vehicle 20, and the traveling image IM2 of the vehicle 20 when the degree of change in the steering angle reaches the threshold value.

The control unit 13 acquires information on the amount of depression of the brake related to driving of the vehicle 20 from the vehicle 20 as operation information. At this time, the control unit 13 determines whether the acquired amount of depression of the brake has reached the threshold value. When the control unit 13 determines that the acquired amount of depression of the brake has reached the threshold value, the control unit 13 generates position information S3 of the vehicle 20 when the amount of depression of the brake reaches the threshold value as improvement information on the traveling environment of the vehicle 20.

In addition, the control unit 13 may generate an improvement method M3 of the traveling environment of the vehicle 20 as the improvement information on the traveling environment of the vehicle 20 based on at least one of the position information S3 of the vehicle 20 and the amount of depression of the brake when the amount of depression of the brake reaches the threshold value.

For example, the control unit 13 may acquire information indicating that there is a traffic light at the point P3 based on the position information S3 of the vehicle 20 when the amount of depression of the brake reaches the threshold value, and generate eliminating the traffic light as the improvement method M3. For example, the control unit 13 may estimate information indicating that there is a traffic light at the point P3 based on the amount of depression of the brake when the amount of depression of the brake reaches the threshold value, and generate eliminating the traffic light as the improvement method M3. For example, the control unit 13 may execute an acquisition process and an estimation process of information related to the traffic light based on the position information S3 of the vehicle 20 and the amount of depression of the brake when the amount of depression of the brake reaches the threshold value, and generate eliminating the traffic light as the improvement method M3.

In addition, the control unit 13 may generate a traveling image IM3 of the vehicle 20 when the amount of depression of the brake reaches the threshold value as the improvement information on the traveling environment of the vehicle 20. As described above, in the example of the process executed by the control unit 13, the improvement information on the traveling environment of the vehicle 20 may include the position information S3 of the vehicle 20 when the amount of depression of the brake reaches the threshold value, the improvement method M3 of the traveling environment of the vehicle 20, and the traveling image IM3 of the vehicle 20 when the amount of depression of the brake reaches the threshold value.

The control unit 13 acquires information on the degree of change in the amount of depression of the brake related to driving of the vehicle 20 from the vehicle 20 as operation information. At this time, the control unit 13 determines whether the acquired degree of change in the amount of depression of the brake has reached the threshold value. When the control unit 13 determines that the acquired degree of change in the amount of depression of the brake has reached the threshold value, the control unit 13 generates position information S4 of the vehicle 20 when the degree of change in the amount of depression of the brake reaches the threshold value as improvement information on the traveling environment of the vehicle 20.

In addition, the control unit 13 may generate an improvement method M4 of the traveling environment of the vehicle 20 as the improvement information on the traveling environment of the vehicle 20 based on at least one of the position information S4 of the vehicle 20 and the degree of change in the amount of depression of the brake when the degree of change in the amount of depression of the brake reaches the threshold value.

For example, the control unit 13 may acquire information indicating that the visibility of the stop line at the point P4 is poor based on the position information S4 of the vehicle 20 when the degree of change in the amount of depression of the brake reaches the threshold value, and generate improving the visibility of the stop line as the improvement method M4. For example, the control unit 13 may estimate information indicating that the visibility of the stop line at the point P4 is poor based on the degree of change in the amount of depression of the brake when the degree of change in the amount of depression of the brake reaches the threshold value, and generate improving the visibility of the stop line as the improvement method M4. For example, the control unit 13 may execute an acquisition process and an estimation process of information related to the visibility of the stop line based on the position information S4 of the vehicle 20 and the degree of change in the amount of depression of the brake when the degree of change in the amount of depression of the brake reaches the threshold value, and generate improving the visibility of the stop line as the improvement method M4.

In addition, the control unit 13 may generate a traveling image IM4 of the vehicle 20 when the degree of change in the amount of depression of the brake reaches the threshold value as the improvement information on the traveling environment of the vehicle 20. As described above, in the example of the process executed by the control unit 13, the improvement information on the traveling environment of the vehicle 20 may include the position information S4 of the vehicle 20 when the degree of change in the amount of depression of the brake reaches the threshold value, the improvement method M4 of the traveling environment of the vehicle 20, and the traveling image IM4 of the vehicle 20 when the degree of change in the amount of depression of the brake reaches the threshold value.

The control unit 13 provides the service facility with the improvement information generated as described above. For example, the control unit 13 provides the generated improvement information to the terminal device 30 of the service facility used by the occupant of the vehicle 20. For example, the control unit 13 transmits the generated improvement information to the terminal device 30 via the communication unit 11 and the network 40.

For example, the position information of the vehicle 20 may include the position of the vehicle 20 traveling in the parking lot of the service facility. That is, the control unit 13 may generate improvement information on the traveling environment in the parking lot of the service facility.

For example, the position information of the vehicle 20 may include the position of the vehicle 20 traveling on the traveling route to the service facility serving as the destination. That is, the control unit 13 may generate the improvement information on the traveling environment on the traveling route to the service facility serving as the destination. At this time, the control unit 13 may receive from the vehicle 20, for example, information on the traveling route to the service facility serving as the destination selected by the occupant of the vehicle 20 using the input unit 25 of the vehicle 20 via the network 40 and the communication unit 11.

For example, the position information of the vehicle 20 may include the position of the vehicle 20 traveling within a predetermined range around the service facility outside the premises of the service facility. That is, the control unit 13 may generate the improvement information on the traveling environment within a predetermined range around the service facility. In the present specification, the “predetermined range” includes, for example, any range appropriately determined by the staff member of the service facility based on the commercial area analysis and the like. The predetermined range may be, for example, a radius of 1 km, a radius of 5 km, or a radius of 10 km.

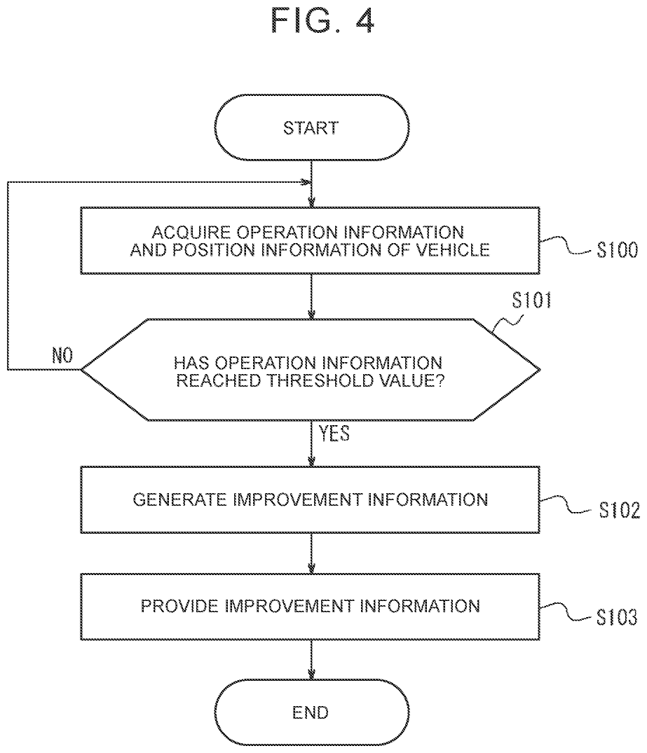

Next, an information processing method executed by the control unit 13 of the information processing device 10 according to the embodiment will be described with reference to FIG. 4. FIG. 4 is a flowchart illustrating an example of an information processing method executed by the information processing device 10 shown in FIG. 1. In the example of the information processing method, a basic flow of the process executed by the control unit 13 of the information processing device 10 will be described.

In step S100, the control unit 13 acquires the operation information related to driving of the vehicle 20 and the position information of the vehicle 20.

In step S101, the control unit 13 determines whether the operation information acquired in step S100 has reached the threshold value. When the control unit 13 determines that the operation information has reached the threshold value, the control unit 13 executes the process of step S102. When the control unit 13 determines that the operation information has not reached the threshold value, the control unit 13 executes the process of step S100 again.

In step S102, when the control unit 13 determines in step S101 that the operation information acquired in step S100 has reached the threshold value, the control unit 13 generates the improvement information on the traveling environment of the vehicle 20 including the position information of the vehicle 20 when the operation information reaches the threshold value.

In step S103, the control unit 13 provides the service facility with the improvement information generated in step S102.

According to the embodiment described above, it is possible to contribute to improving the management efficiency of the service facility by improving the traveling environment of the vehicle 20. For example, the information processing device 10 generates the improvement information based on the acquired operation information and the position information of the vehicle 20 and provides the improvement information to the service facility, so that the staff member of the service facility can actually confirm the point corresponding to the position information of the vehicle 20 included in the improvement information. That is, the staff member of the service facility can actually move to a point including some kind of factor related to the traveling environment that causes the operation information to reach the threshold value in the operation related to driving of the vehicle 20, and can confirm the traveling environment on site.

As a result, the staff member of the service facility can analyze the factors that cause the operation information to reach the threshold value, examine an improvement method that eliminates such factors, and take measures to improve the traveling environment. By improving the traveling environment at a predetermined point on or outside the premises of the service facility, the vehicle 20 can be driven more safely and smoothly at such a point. Therefore, the occupant of the vehicle 20 can use the service facility more readily. As a result, the rate of attracting customers to the service facility will improve, which will improve the management efficiency.

The information processing device 10 can also propose the improvement method of the traveling environment to the staff member of the service facility by generating the improvement information including the improvement method of the traveling environment based on the position information of the vehicle 20 or the operation information when the operation information reaches the threshold value. As a result, the staff member of the service facility can omit to some extent work such as analysis of the factors that cause the operation information to reach the threshold value and examination of the improvement method that eliminates such factors, making it possible to reduce the burden for improving the management efficiency. That is, the staff member of the service facility can efficiently formulate and execute the management strategy for improving the management efficiency.

The information processing device 10 can accurately determine an appropriate improvement method that can eliminate such factors that cause the operation information to reach the threshold value by generating the improvement information including the improvement method of the traveling environment based on both the position information of the vehicle 20 and the operation information when the operation information reaches the threshold value.

The information processing device 10 can also provide the traveling image of the vehicle 20 to the staff member of the service facility by generating the improvement information including the traveling image of the vehicle 20 when the operation information reaches the threshold value. As a result, the staff member of the service facility can grasp to some extent the traveling environment at the point corresponding to the position information of the vehicle 20 included in the improvement information from the traveling image of the vehicle 20. The staff member of the service facility can confirm the traveling environment with the traveling image without actually moving to a point including some kind of factor related to the traveling environment that causes the operation information to reach the threshold value in the operation related to driving of the vehicle 20. Therefore, the staff member of the service facility can reduce the burden for improving the management efficiency. That is, the staff member of the service facility can efficiently formulate and execute the management strategy for improving the management efficiency.

The position information includes the position of the vehicle 20 traveling in the parking lot of the service facility, and the information processing device 10 generates the improvement information on the traveling environment in the parking lot, so that the staff member of the service facility can improve the traveling environment of the parking lot provided on the premises of the service facility. By improving the traveling environment of the parking lot provided on the premises of the service facility, the vehicle 20 can be driven more safely and smoothly in the parking lot. Therefore, the occupant of the vehicle 20 can use the service facility more readily. As a result, the rate of attracting customers to the service facility will improve, which will improve the management efficiency.

In addition, the staff member of the service facility can improve the traveling environment of the parking lot provided on the premises of the service facility to suppress accidents of the vehicle 20 from occurring in the parking lot. Therefore, the management of the service facility becomes more stable.

The position information includes the position of the vehicle 20 traveling on the traveling route to the service facility serving as the destination, and the information processing device 10 generates the improvement information on the traveling environment on the traveling route, so that the staff member of the service facility can improve the traveling environment on the traveling route to the service facility serving as the destination. Even outside the premises of the service facility, by improving the traveling environment on the traveling route, the vehicle 20 can be driven more safely and smoothly on the traveling route to the service facility. Therefore, the occupant of the vehicle 20 can use the service facility more readily. As a result, the rate of attracting customers to the service facility will improve, which will improve the management efficiency.

The position information includes the position of the vehicle 20 traveling within a predetermined range around the service facility outside the premises of the service facility, and the information processing device 10 generates the improvement information on the traveling environment within the predetermined range, so that the staff member of the service facility can improve the traveling environment within the predetermined range from the service facility. Even outside the premises of the service facility, by improving the traveling environment within the predetermined range, the vehicle 20 can be driven more safely and smoothly within the predetermined range from the service facility. Therefore, the occupant of the vehicle 20 can use the service facility more readily. As a result, the rate of attracting customers to the service facility will improve, which will improve the management efficiency.

Since the operation information is related to the autonomous driving of the vehicle 20, the information processing device 10 can generate the improvement information based on the operation information of the vehicle 20 that performs the autonomous driving. The staff member of the service facility can grasp a point including some kind of factor related to the traveling environment that causes the operation information to reach the threshold value even in the operation related to the autonomous driving of the vehicle 20 that is more accurate than manual driving by the occupant. As a result, the staff member of the service facility can actually move to the point including such factors and confirm the traveling environment on site. Similarly, the staff member of the service facility can analyze such factors, examine an improvement method that eliminates such factors, and take measures to improve the traveling environment.

Although the present disclosure has been described above based on the drawings and the embodiment, it should be noted that those skilled in the art can make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, at least a part of the processing operations executed by the information processing device 10 in the above embodiment may be executed by the vehicle 20. For example, instead of the information processing device 10, the vehicle 20 itself may execute the processing operations described above related to the information processing device 10. At least a part of the processing operations executed by the vehicle 20 may be executed by the information processing device 10.

For example, a general-purpose electronic device such as a smartphone or a computer may be configured to function as the information processing device 10 according to the above embodiment. Specifically, a program including processing content for realizing each function of the information processing device 10 and the like according to the embodiment is stored in a memory of the electronic device, and the program is read and executed by the processor of the electronic device. Thus, the disclosure according to the embodiment can also be realized as a program that can be executed by the processor. Alternatively, the disclosure according to the embodiment can also be realized as a non-transitory computer-readable medium that stores a program executable by one or more processors to cause the information processing device 10 etc. according to the embodiment to execute each function. It should be understood that the above configurations are also included in the scope of the present disclosure.

For example, the information processing device 10 described in the above embodiment may be mounted on the vehicle 20. With the configuration above, the information processing device 10 may directly perform information communication with the vehicle 20 without the network 40.

In the above embodiment, it has been described that the improvement information includes the improvement method of the traveling environment of the vehicle 20 and the traveling image of the vehicle 20 when the operation information reaches the threshold value in addition to the position information of the vehicle 20 when the operation information reaches the threshold value, but the present disclosure is not limited to this. The improvement information only needs to include at least the position information of the vehicle 20 when the operation information reaches the threshold value.

In the above embodiment, it has been described that the information processing system 1 includes the information processing device 10, the vehicle 20, and the terminal device 30, but the present disclosure is not limited thereto. The information processing system 1 may include only the information processing device 10 and the vehicle 20 without the terminal device 30 of the service facility.

What is claimed is:

1. An information processing device comprising a control unit that
acquires operation information related to driving of a vehicle and position information of the vehicle,
generates improvement information on a traveling environment of the vehicle when the control unit determines that the operation information that is acquired has reached a threshold value, the improvement information including the position information when the operation information reaches the threshold value, and
provides the improvement information that is generated to a service facility.

2. The information processing device according to claim 1, wherein the control unit generates the improvement information including an improvement method of the traveling environment based on at least one of the position information and the operation information when the operation information reaches the threshold value.

3. The information processing device according to claim 1, wherein the control unit acquires a traveling image in which an outside of the vehicle is imaged and generates the improvement information including the traveling image when the operation information reaches the threshold value.

4. The information processing device according to claim 1, wherein:
the position information includes a position of the vehicle traveling in a parking lot of the service facility; and
the control unit generates the improvement information on the traveling environment in the parking lot.

5. The information processing device according to claim 1, wherein:
the position information includes a position of the vehicle traveling on a traveling route to the service facility serving as a destination; and
the control unit generates the improvement information on the traveling environment in the traveling route.

6. The information processing device according to claim 1, wherein:
the position information includes a position of the vehicle traveling within a predetermined range around the service facility outside premises of the service facility; and
the control unit generates the improvement information on the traveling environment within the predetermined range.

7. The information processing device according to claim 1, wherein the operation information is related to autonomous driving of the vehicle.

8. An information processing system comprising:
the information processing device according to claim 1; and
the vehicle that provides the information processing device with the operation information and the position information.

9. A program that causes an information processing device to perform operations including:
acquiring operation information related to driving of a vehicle and position information of the vehicle;
determining whether the operation information that is acquired has reached a threshold value;
generating improvement information on a traveling environment of the vehicle when the information processing device determines that the operation information that is acquired has reached the threshold value, the improvement information including the position information when the operation information reaches the threshold value; and
providing the improvement information that is generated to a service facility.

10. The program according to claim 9, wherein the operations include generating the improvement information including an improvement method of the traveling environment based on at least one of the position information and the operation information when the operation information reaches the threshold value.

11. The program according to claim 9, wherein the operations include acquiring a traveling image in which an outside of the vehicle is imaged and generating the improvement information including the traveling image when the operation information reaches the threshold value.

12. The program according to claim 9, wherein:
the position information includes a position of the vehicle traveling in a parking lot of the service facility; and
the operations include generating the improvement information on the traveling environment in the parking lot.

13. The program according to claim 9, wherein:
the position information includes a position of the vehicle traveling on a traveling route to the service facility serving as a destination; and
the operations include generating the improvement information on the traveling environment in the traveling route.

14. The program according to claim 9, wherein:
the position information includes a position of the vehicle traveling within a predetermined range around the service facility outside premises of the service facility; and
the operations include generating the improvement information on the traveling environment within the predetermined range.

15. A vehicle comprising a control unit that
acquires operation information related to driving of the vehicle and position information of the vehicle,
generates improvement information on a traveling environment of the vehicle when the control unit determines that the operation information that is acquired has reached a threshold value, the improvement information including the position information when the operation information reaches the threshold value, and
provides the improvement information that is generated to a service facility.

16. The vehicle according to claim 15, wherein the control unit generates the improvement information including an improvement method of the traveling environment based on at least one of the position information and the operation information when the operation information reaches the threshold value.

17. The vehicle according to claim 15, wherein the control unit acquires a traveling image in which an outside of the vehicle is imaged and generates the improvement information including the traveling image when the operation information reaches the threshold value.

18. The vehicle according to claim 15, wherein:
the position information includes a position of the vehicle traveling in a parking lot of the service facility; and
the control unit generates the improvement information on the traveling environment in the parking lot.

19. The vehicle according to claim 15, wherein:
the position information includes a position of the vehicle traveling on a traveling route to the service facility serving as a destination; and
the control unit generates the improvement information on the traveling environment in the traveling route.

20. The vehicle according to claim 15, wherein:
the position information includes a position of the vehicle traveling within a predetermined range around the service facility outside premises of the service facility; and
the control unit generates the improvement information on the traveling environment within the predetermined range.
